(19) United States
(12) Patent Application Publication
(10) Pub. No.: US 2025/0013700 A1
(43) Pub. Date: Jan. 9, 2025

(54) BOOK SEARCH METHOD, APPARATUS, DEVICE AND STORAGE MEDIUM

(71) Applicant: Beijing Bytedance Network Technology Co., Ltd., Shijingshan District, Beijing (CN)

(72) Inventors: Huiran Guan, Beijing (CN); Jinghua Li, Beijing (CN); Weisong Chen, Beijing (CN); Zhiqi Yu, Beijing (CN); Jing Qu, Beijing (CN)

(21) Appl. No.: 18/710,992

(22) PCT Filed: Mar. 29, 2023
(86) PCT No.: PCT/CN2023/084768

§ 371 Date: May 16, 2024

(30) Foreign Application Priority Data
Apr. 15, 2022 (CN) 202210399916.3

(51) Int. Cl. G06F 16/9535; G06F 16/9538

(52) U.S. Cl. CPC G06F 16/9535; G06F 16/9538

(57) ABSTRACT

The present disclosure relates to a book search method, apparatus, device and storage medium. In the method, target search content is received. A plurality of recommended book categories associated with the target search content and book information corresponding to respective recommended book categories are obtained. A book aggregation card is generated based on the respective recommended book categories and the book information, and the book aggregation card is displayed on a search result page. According to the embodiments of the present disclosure, the user can directly view, on the search result page, the plurality of recommended book categories associated with the target search content and the book information under each recommended book category. Therefore, the user search cost is reduced, the book search flow is simplified, and the book search efficiency is improved.

### CROSS REFERENCE TO RELATED APPLICATIONS

This application is based on Chinese Patent Application No. 202210399916.3, filed with the Chinese Patent Office on Apr. 15, 2022 and entitled “BOOK SEARCH METHOD, APPARATUS, DEVICE AND STORAGE MEDIUM” and claims priority to this application, the disclosures of which are incorporated herein by reference in their entities.

### FIELD

The present disclosure relates to the technical field of search, and in particular, to a book search method, apparatus device and storage medium.

### BACKGROUND

In the book search field, generally, a user inputs search content in a client, the client sends the search content to a search engine, and then the search engine returns a book category result or a book result corresponding to the search content and displays the same in the client. If the book category result or the book result does not include the search result required by the user, then the user has to re-input new search content to repeat the above book searching process.

However, in the described process, a user needs to repeatedly determine appropriate search content and repeatedly perform search operations as well as browse and judge search results, which leads to an elaborate book search process and low search efficiency.

### SUMMARY

In order to solve the above technical problem, the present disclosure provides a book search method, apparatus, device and a storage medium.

In a first aspect, the present disclosure provides a book search method. The method comprises:
receiving target search content;
obtaining a plurality of recommended book categories associated with the target search content, and book information corresponding to respective recommended book categories; and
generating a book aggregation card based on the respective recommended book categories and the book information, and displaying the book aggregation card on a search result page.

According to a second aspect, the present disclosure provides a book search apparatus. The apparatus comprises:
a search content receiving module configured for receiving target search content;
a recommended book category obtaining module configured for obtaining a plurality of recommended book categories associated with the target search content, and book information corresponding to respective recommended book categories; and
a book aggregation card displaying card configured for generating a book aggregation card based on the respective recommended book categories and the book information, and displaying the book aggregation card on a search result page.

According to a third aspect, the present disclosure provides an electronic device. The device comprises:
a processor;
a memory for storing executable instructions;
wherein the processor is configured for reading the executable instructions from the memory and executing the executable instructions to implement the book search method as described in any of the embodiments of the present disclosure.

In a fourth aspect, the present disclosure provides a computer readable storage medium, storing a computer program thereon. The computer program, when executed by a processor, causes the processor to implement the book search method as described in any of the embodiments of the present disclosure.

By means of the book search method, apparatus, device and storage medium of the embodiments of the present disclosure, a plurality of recommended book categories associated with target search content input by a user and book information corresponding to the respective recommended book categories can be obtained, a book aggregation card can be generated based on the respective recommended book categories and the book information, and the book aggregation card can be displayed on a search result page. In this way, the user can directly view on the search result page, the plurality of recommended book categories associated with the target search content and the book information under each recommended book category without repeating the book search operation and the search result filtering operation. Therefore, the user search cost is reduced, the book search flow is simplified, and the book search efficiency is improved.

### BRIEF DESCRIPTION OF THE DRAWINGS

Through the more detailed description of detailed implementations with reference to the accompanying drawings, the above and other features, advantages and aspects of respective embodiments of the present disclosure will become more apparent. The same or similar reference numerals represent the same or similar elements throughout the figures. It should be understood that the figures are merely schematic, and components and elements are not necessarily drawn scale.

FIG. 1 is a schematic flowchart of a book search method provided by an embodiment of the present disclosure;

FIG. 2 is a schematic diagram of displaying a search result page provided by an embodiment of the present disclosure;

FIG. 3 is a schematic diagram of displaying a further search result page provided by an embodiment of the present disclosure;

FIG. 4 is a schematic diagram of displaying a still further search result page provided by an embodiment of the present disclosure;

FIG. 5 is a structural schematic diagram of a book search apparatus provided by an embodiment of the present disclosure; and

FIG. 6 is a structural schematic diagram of an electronic device provided by an embodiment of the present disclosure.

### DETAILED DESCRIPTION

The embodiments of the present disclosure will be described in more detail with reference to the accompanying drawings, in which some embodiments of the present disclosure have been illustrated. However, it should be understood that the present disclosure can be implemented in various manners, and thus should not be construed to be limited to embodiments disclosed herein. On the contrary, those embodiments are provided for the thorough and complete understanding of the present disclosure. It should be understood that the drawings and embodiments of the present disclosure are only used for illustration, rather than limiting the protection scope of the present disclosure.

It should be understood that various steps described in method implementations of the present disclosure may be performed in a different order and/or in parallel. In addition, the method implementations may comprise an additional step and/or omit a step which is shown. The scope of the present disclosure is not limited in this regard.

The term “comprise” and its variants used here are to be read as open terms that mean “include, but is not limited to.” The term “based on” is to be read as “based at least in part on.” The term “one embodiment” are to be read as “at least one embodiment.” The term “another embodiment” is to be read as “at least one other embodiment.” The term “some embodiments” are to be read as “at least some embodiments.” Other definitions will be presented in the description below.

Note that the concepts “first,” “second” and so on mentioned in the present disclosure are only for differentiating different apparatuses, modules or units rather than limiting the order or mutual dependency of functions performed by these apparatuses, modules or units.

Note that the modifications “one” and “a plurality” mentioned in the present disclosure are illustrative rather than limiting, and those skilled in the art should understand that unless otherwise specified, they should be understood as “one or more.”

Names of messages or information interacted between a plurality of apparatuses in the implementations of the present disclosure are merely for the illustration purpose, rather than limiting the scope of these messages or information.

In the current book search process, after a user searches for a certain book category, categories that are directly hit by the search and include a search keyword will be shown to the user. However, different user groups may have different subdivision requirements for the same book category, and thus the search results fed back by the search engine cannot meet the search requirements of different users. After a user searches for a book, book information that is hit directly by the search and includes a search keyword will be shown to the user. However, different user groups may have requests to find other books in dimensions such as in the same book category or by the same author. Likewise, the search results fed back by the search engine cannot meet the search requirements of different users.

In view of the above situations, the embodiments of the present disclosure provide a book search solution to realize that a plurality of recommended book categories associated with target search content and book information contained under the recommended book categories are displayed to a user by a single search action of the target search content. Thus, the process of the user repeatedly modifying search content and initiating book search is avoided, and the labor cost and time cost of searching books by the user are saved, and further, the book search efficiency is increased, and the user experience is improved.

The book search method provided by the embodiment of the present disclosure may be applicable to a scenario of searching for books in a book application, a browser or other application having a search function. The method can be executed by a book search apparatus. The apparatus can be implemented by software and/or hardware and can be integrated in an electronic device having input and display functions. The electronic device may include, but is not limited to, a mobile terminal such as a smartphone, a notebook computer, a personal digital assistant (PDA), a tablet personal computer (Tablet PC), a PMP (Portable Multimedia Player), an onboard terminal (for example, an onboard navigation terminal), a wearable device and the like, as well as a fixed terminal such as a digital television, a desktop computer, a smart home device and the like.

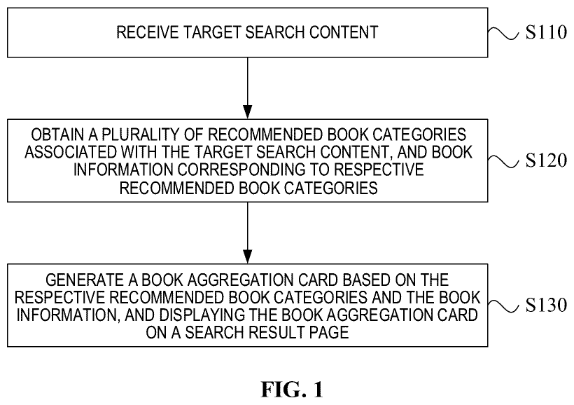

FIG. 1 shows a schematic flowchart of a book search method according to an embodiment of the present disclosure. As shown in FIG. 1, the book search method may comprise:

S110, receiving target search content.

In the embodiments of the present disclosure, the target search content refers to search content input by the user and related to books. The search content refers to content that needs a search engine to perform a search operation and feed back a search result. The search content may be a keyword, a complete long sentence or a short sentence.

In particular, the electronic device may receive the target search content input by the user within a content search page of a specific application or a specific website.

In some embodiments, the user may input information in any form of text, voice, and image in a search box of the search page, so that the electronic device uses the text corresponding to the information input by the user as the search content input by the user. For example, the user may input “eschatology” or “culture **” in the search box, and the electronic device uses the input text as the target search content.

In other embodiments, a plurality of candidate search content may be displayed in the search page, and the user may select from the displayed candidate search content, so that the electronic device uses the candidate search content selected by the user as the search content. For example, with regard to a hot book or a hot book category, a plurality of candidate search content corresponding to the book “XXX” or the book category “XX” are displayed in a search box, below the search box or in other areas of the search page, and the user may select, from the candidate search content, candidate search content of interest as the target search content.

In the embodiments of the present disclosure, after receiving the target search content input by the user, the electronic device may send the same to a server. After receiving the target search content, the server performs content recognition and search on the target search content.

First, the server recognizes the target search content so as to determine category search content or book search content to which the target search content belongs. The category search content refers to search content initiating a search for a book category, and the book search content refers to search content initiating a search for a specific book. In an example, a book name list and a book category list are pre-stored in the server. The server matches a keyword corresponding to the target search content and similar words of the keyword with content in the book name list and the book category list respectively. If the book name list is successful matched, it is determined that the target search content is the book search content, and specifically the name of the successfully matched book. If the book category list is successfully matched, it is determined that the target search content is the category search content, and specifically the name of the matched book category. In another example, a trained machine learning model is pre-stored in the server. The server inputs the target search content into the trained machine learning model, and through model calculation, can output that the target search content belongs to category search content or book search content. In yet another example, the book name list, the book category list and the trained machine learning model may be stored simultaneously in the server. The server firstly matches the target search content with the book name list and the book category list, and if the matching is successful, performs processing according to the above first example. If the matching fails, the server performs processing according to the second example above.

Then, the server searches the recognized category search content or book search content to determine a comprehensive search result corresponding to the target search content, a plurality of recommended book categories associated with the target search content, and book information about at least one book contained in each recommended book category. Afterwards, the server feeds back the comprehensive search result, the plurality of recommended book categories and the corresponding book information to the electronic device.

S120, obtaining a plurality of recommended book categories associated with the target search content, and book information corresponding to respective recommended book categories.

In the embodiments of the present disclosure, the recommended book category refers to a book category having correlation to the target search content and being recommended and displayed to the user. In some embodiments, the recommended book category is a primary book category or a secondary book category. The primary book category and the secondary book category refer to book categories that belong to an upper-lower level relationship in a book classification system respectively, and may be, for example, a main category and a subcategory in a main category in the book classification system respectively. The book classification system may be an existing classification system in the related art, or an emerging classification system derived from mining books and data on user-authorized book-related behaviors. In this example, the recommended book category may be a primary book category or a secondary book category. That is, the plurality of recommended book categories fed back by the server are not limited to the levels of the book categories, as long as they have correlation with the target search content.

The book information refers to relevant information describing a book. In an example, the book information includes a book identifier, which includes a picture of the book and/or a name of the book. In another example, the book information includes a book identifier and book interaction information. The book interaction information includes a user's review of the book, the number of likes, a rating, the number of shares, etc. In this way, greater-dimensional reference information can be provided for a user to select a book, thereby improving the efficiency of the user in filtering books.

Specifically, book categories that can be provided in the related art for filtering and searching books are fixed categories that are set in advance, for example, various levels of book categories in an existing book classification system are displayed. In this case, each book category displayed is independent of the target search content input by the user, that is, no matter what search content is input by the user, the same book category is displayed. Hence, although a plurality of book categories are displayed for the user to filter books, the user still has to understand each book category and repeatedly attempt to select a book category so as to filter out a desired book, which also causes a low efficiency of book search. In this case, the plurality of displayed book categories instead act as a reaction that interferes with user search, thereby causing poor user experience.

In view of the above situations, in the embodiments of the present disclosure, during the process of searching by the server, at least two book categories having a certain correlation with the target search content need to be filtered out from many book categories, as recommended book categories to be fed back to the electronic device. In this way, the electronic device can obtain a plurality of recommended book categories having an association with the target search content, and book information of books included in the respective recommended book categories. Thus, not only the information content in the search result page can be increased, but also the obtained recommended book categories are all book categories related to the target search content input by the user, which can reflect the search demands of the user to some extent without causing search interference to the user. Moreover, guidance can be provided for user search, the book search efficiency of the user can be increased, and the user search experience can be improved.

S130, generating a book aggregation card based on the respective recommended book categories and the book information, and displaying the book aggregation card in the search result page.

In the embodiments of the present disclosure, the book aggregation card is a display card aggregating information related to a plurality of books.

Specifically, the electronic device generates a book aggregation card based on the respective recommended book categories and the corresponding book information as received, so that each recommended book category and the corresponding book information can be displayed in a centralized manner. Then, the book aggregation card is then displayed in the search result page.

In some embodiments, the displaying the book aggregation card in the search result page in S130 comprises: displaying the book aggregation card at a predetermined location of the search result page; in the book aggregation card, displaying the respective recommended book categories in a navigation style or a list style, displaying a target book category in the respective recommended book categories in a first predetermined style, displaying further book categories in the respective recommended book categories in a second predetermined style, and displaying the book information corresponding to the target book category.

In the embodiments of the present disclosure, the predetermined location is a predetermined location for displaying information on the search result page. The first predetermined style and the second predetermined style are respectively predetermined display styles of controls where book categories are located, and display effects of the first predetermined style and the second predetermined style are different. For example, the display effect of the first predetermined style may be stronger than that of the second predetermined pattern, so as to achieve an objective of highlighting a control displayed according to the first predetermined style. The target book category refers to a recommended book category which is hit, for example, may be a recommended book category which is arranged at a specific location (e.g., first, middle, etc.), or may be a recommended book category which is hit directly by the target search content. The other book categories are other recommended book categories than the target book category among the obtained recommended book categories.

Specifically, the electronic device displays the book aggregation card at a predetermined location of the search result page. In the book aggregation card, first, each recommended book category is displayed in a side area (e.g., upper-side edge area, lower-side edge area, left-side edge area, or right-side edge area) of the book aggregation card in a navigation style or a list style. Meanwhile, in order to highlight the target book category, the electronic device displays the target book category in the first predetermined style and other book categories in the second predetermined style. Then, the book information corresponding to the target book category is displayed in the remaining area of the book aggregation card.

In some embodiments, the above predetermined location is related to whether the target search content is category search content or book search content.

In an example, when the target search content is the category search content, the search result page first displays/highlights a search result entry related to the book category, and the book aggregation card contains the respective recommended book categories. Hence, in this case, the predetermined location may be a first area adjacent to the top of the page. The displaying the book aggregation card at the predetermined location of the search result page comprises: displaying the book aggregation card in the first area of the search result page.

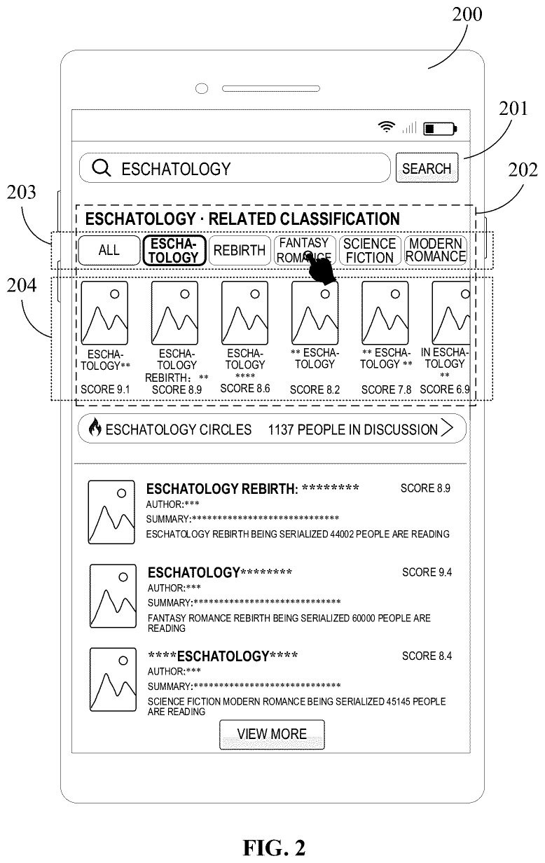

With reference to FIG. 2, the target search content is the category search content “eschatology”. A search result page 201 is displayed in an electronic device 200, and a book aggregation card “eschatology·related classification” is displayed in a first area 202 of the search result page 201. Each recommended book category 203 is displayed on the upper edge of the book aggregation card. In addition, the electronic device displays the target book category “eschatology” in a first predetermined style with bold text and borders, and displays other book categories such as “rebirth”, “fantasy romance”, “science fiction”, and “modern romance” in a second predetermined style with non-bold text and borders, etc. Further, the electronic device displays a plurality of book information 204 corresponding to the target book category “eschatology” in the lower half area of the book aggregation card.

As shown in FIG. 2, related information of discussion circles corresponding to the target book category may further be displayed on the search result page, so as to provide the user with book category information of more dimensions.

In another example, when the target search content is the book search content, the search result entry (namely, the book search result) related to a book which is hit should be first displayed/highlighted in the search result page. Hence, in this case, the book search result will be displayed in the above first area, and the book aggregation card can be displayed in an adjacent display area (i.e., the second area) arranged after the first area. That is, the displaying the book aggregation card at the predetermined location of the search result page comprises: displaying the book aggregation card in the second area of the search result page.

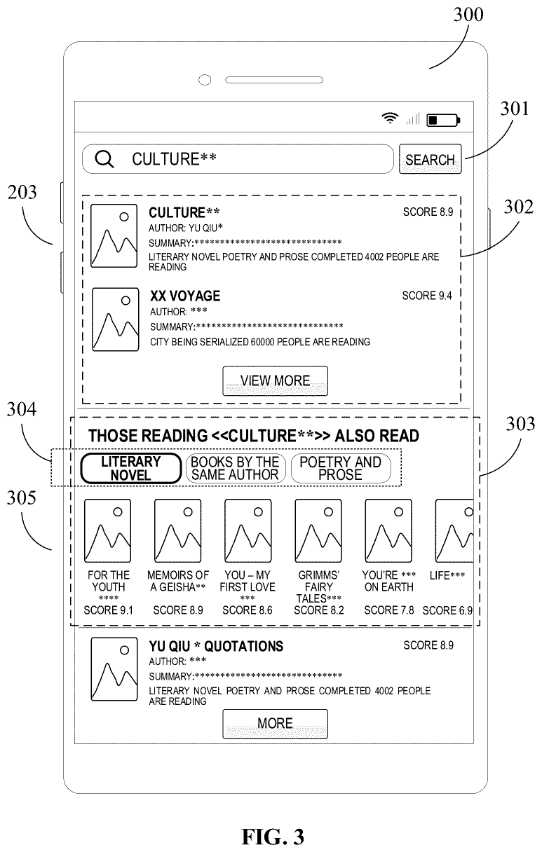

With reference to FIG. 3, the target search content is book search content “culture **.” A search result page 301 is displayed in an electronic device 300, and a plurality of book search results are displayed in a first area 302 of the search result page 301. A book aggregation card “those read <<culture **>> also read” is displayed in an adjacent second area 303 immediately below the first area 302. Each recommended book category 304 is displayed on the upper edge of the book aggregation card. In addition, the electronic device displays the target book category “literary novel” in the first predetermined style with bold text and borders, and displays the respective other book categories “books by the same author” and “poetry and prose” in the second predetermined style with no bold text or borders. Furthermore, the electronic device displays a plurality of book information 305 corresponding to the target book category “literary novel” in the lower half area of the book aggregation card.

In some embodiments, after S130, the book search method further comprises: in response to a trigger operation on any of the further book categories among the respective recommended book categories, displaying the triggered further book category in a first predetermined style, displaying the untriggered further book categories and the target book category in a second predetermined style, and displaying the book information corresponding to the triggered further book category.

Specifically, in response to the user's operation of switching a recommend book category, the electronic device modifies the display style of the control of each recommended book category, and synchronously switches to display the book information below.

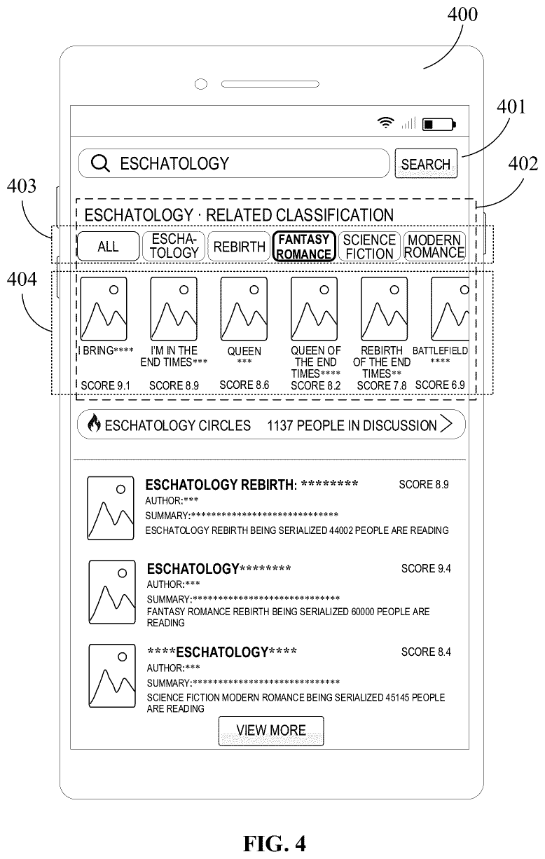

For example, with reference to FIG. 2, if the user clicks and triggers “fantasy romance” in other book categories, in response to the click and trigger operation, the electronic device will synchronously switch the display content and display style in the book aggregation card, and the display effect is as shown in FIG. 4. With reference to FIG. 4, regarding the target search content as the category search content “eschatology”, an electronic device 400 displays still a book aggregation card “eschatology” in a first area 402 of a search result page 401, and the same recommended book categories 403 are still on the upper edge of the book aggregation card. However, the electronic device displays the triggered other book category “fantasy romance” in a first predetermined style with bold text and borders, and displays the previous target book category “eschatology” and various other book categories “rebirth”, “science fiction”, “modern romance” and the like in a second predetermined style with no bold text or borders. Furthermore, the electronic device displays a plurality of book information 404 corresponding to the triggered other book category “fantasy romance” in the lower half area of the book aggregation card.

The book search method provided in the embodiments of the present disclosure can obtain a plurality of recommended book categories related to target search content input by a user and book information corresponding to each recommended book category, generate a book aggregation card based on each recommended book category and the book information, and display the book aggregation card on a search result page. In this way, the user can directly view on the search result page, the plurality of recommended book categories associated with the target search content and the book information under each recommended book category without repeating the book search operation and the search result filtering operation. Therefore, the user search cost is reduced, the book search flow is simplified, and the book search efficiency is improved.

In some embodiments, the recommended book category is determined based on at least one of a first book category, a second book category and a third book category.

In the embodiments of the present disclosure, the first book category comprises a book category to which a keyword corresponding to the target search content belongs. That is, the first book category is a book category which is directly hit by the target search content.

In one example, where the target search content is category search content, the first book category includes a book category that matches keywords included in the category search content. When the target search content is the category search content, the server extracts a keyword from the category search content and matches the book category with the keyword (reference can be made to the description in S110), so as to obtain a book category with the highest match degree as the first book category.

In another example, where the target search content is book search content, the first book category includes a book category to which a category keyword corresponding to a target book hit by the book search content belongs, and/or a book category corresponding to a book attribute of the target book. The book attribute comprises at least one of author, chronological or event context corresponding to the book content, book length, and book status. The book status may include a book completion status indicating whether the book has been completed, a book popularity status indicating whether the book is a masterpiece, etc. When the target search content is the book search content, the server first extracts a keyword from the book search content and matches a target book with the keyword. Then, the server will determine a book category corresponding to the target book from category keywords (or referred to as category labels) carried in the target book, as the first book category. In addition, the server may further mine a book category according to attribute information of the target book. For example, the author of the target book is determined as an author category, the chronological or event context described by the book content of the target book is determined as a chronological category, the book length of the target book is determined as a length category, and the book completion status indicating whether the book has been completed or the book popularity status indicating whether the book is a masterpiece is determined as a book status category, etc. Thus, the server can determine at least one first book category according to the target book, and each first book category is associated with the target search content and thus can be used for search consumption based on a related book category of the target book.

In the embodiments of the present disclosure, the second book category includes a book category with an overlap degree of books corresponding to the first book category reaching a predetermined threshold. When the server mines the second book category, processing is performed from the perspective of the overlap degree of books contained under each book category. For example, there are 34 books contained under the first book category and 50 books contained under a certain book category, and some of these books overlap with each other, and then the number of overlapping books or the percentage of overlapping books among the books contained under the first book category can be defined as an overlap degree of books. It can be understood that the higher the overlap degree of books, the higher the correlation between two book categories. The server can calculate the overlap degree of books between each book category and the first book category, and determine a book category with an overlap degree of books reaching a predetermined critical value of overlap degree (namely, a predetermined threshold) as the second book category. According to the above description, there is a certain correlation between the second book category and the first book category, and therefore the second book category also has a correlation with the target search content and can also be used for realizing the search and consumption based on the related book category of the target book.

In the embodiments of the present disclosure, the third book category includes a book category extracted from book interaction behavior data corresponding to the target search content. The book interaction behavior data is user behavior data authorized by the user and used for book-related operations (such as searching, reading, commenting, sharing, liking, etc.). As an example, the book interaction behavior data comprises at least one of a book category hit by the continuously triggered category search content, a book hit by the continuously triggered book search content and a book already read. The book category hit by the continuously triggered category search content refers to a book category hit by the category search content input by the user in many consecutive book search behaviors, for example, the first book category hit by the book search content input in multiple consecutive book searches of some user or users for “eschatology”. The books hit by the continuously triggered book search content refer to the first book category corresponding to the book hit by the book search content input by the user in multiple consecutive book search behaviors, for example, the first book category hit by the book search content input in multiple consecutive book searches of the user for the book “culture **”. The above-mentioned book that has been read refers to the first book category corresponding to books that have been read historically by a plurality of users, for example, the first book category corresponding to read books by the user within the period of reading the book “culture **”. The server can obtain book interaction behavior data which has been authorized by the user within a certain period of time, and then extract the book category from the obtained book interaction behavior data according to the above process, so as to obtain a third book category. Since the book interaction behavior data can reflect, to some extent, search requirements of the user for the target search content, the third book category obtained in the above process is also associated with the target search content and can also be used for realizing search consumption based on a related book category of the target book.

Specifically, according to the above description, the first book category, the second book category and the third book category are all book categories having correlation with the target search content. Therefore, in the process of searching for the target search content, the server can obtain the first book category, the second book category and the third book category from many book categories in the book category mining manner in as described above, and determine at least one of the first book category, the second book category, and the third book category as a recommended book category.

In some embodiments, the respective recommended book categories in the book aggregation card are ranked based on category relevance.

Specifically, in order to further improve the user's book search efficiency, in the embodiments of the present disclosure, the recommended book categories may be ranked by category relevance, so as to arrange the recommended book category with higher relevance to the target search content in a higher position.

In the embodiments of the present disclosure, the category relevance is determined based on at least one of search frequency of each recommended book category, an overlap degree of books between the target book category and each other book category, and associated search closeness between each recommended book category.

The search frequency of each recommended book category refers to the number or frequency of book searches initiated using each recommended book category as category search content in the above book interaction behavior data. The higher the search frequency, the higher the user attention for the recommended the book category, and the higher the category relevance to the target search content.

The overlap degree of books between the target book category and each other book category refers to the overlap degree of books between the respective other book categories and the target book category. Since the target book category is a book category directly hit by the target search content, the relevance between the target book category and the target search content is the highest, and the higher the overlap degree of books between other book category and the target book category, the higher the category relevance between the other book category and the category of the target search content.

The associated search closeness between the recommended book categories refers to the number or the ratio of any two recommended book categories being used as the search content of consecutive searches in the above book interaction behavior data. For example, for the target recommended book category and a certain other recommended book category, in the above book interaction behavior data, after the target recommended book category is searched for, the number of searches for the other recommended book category or the ratio of the number of searches to the total number of searches can be taken as the associated search closeness between the target recommended book category and the other recommended book category. It can be seen that the higher the associated search closeness, the higher the relevance between the two corresponding recommended book categories. Then, according to the above process, the server can calculate the associated search closeness degree between each other recommended book category and the target book category, and obtain the category relevance between each recommended book category and the target search content according to the associated search closeness.

Specifically, the server can obtain the category relevance in three dimensions corresponding to each recommended book category according to the described various category relevance calculation methods. Then, the server may use any of the search frequency, the overlap degree of books and the associated search closeness as the category relevance corresponding to each recommended book category. Alternatively, the server may perform weighted calculation on any two or three of the search frequency, the overlap degree of books and the associated search closeness to obtain a comprehensive value as the category relevance corresponding to each recommended book category.

The following is an embodiment of a book search apparatus provided in the embodiments of the present disclosure. The apparatus and the book search method in the foregoing embodiments belong to the same inventive concept. For details not described in detail in the embodiment of the book search apparatus, reference may be made to the embodiments of the book search method.

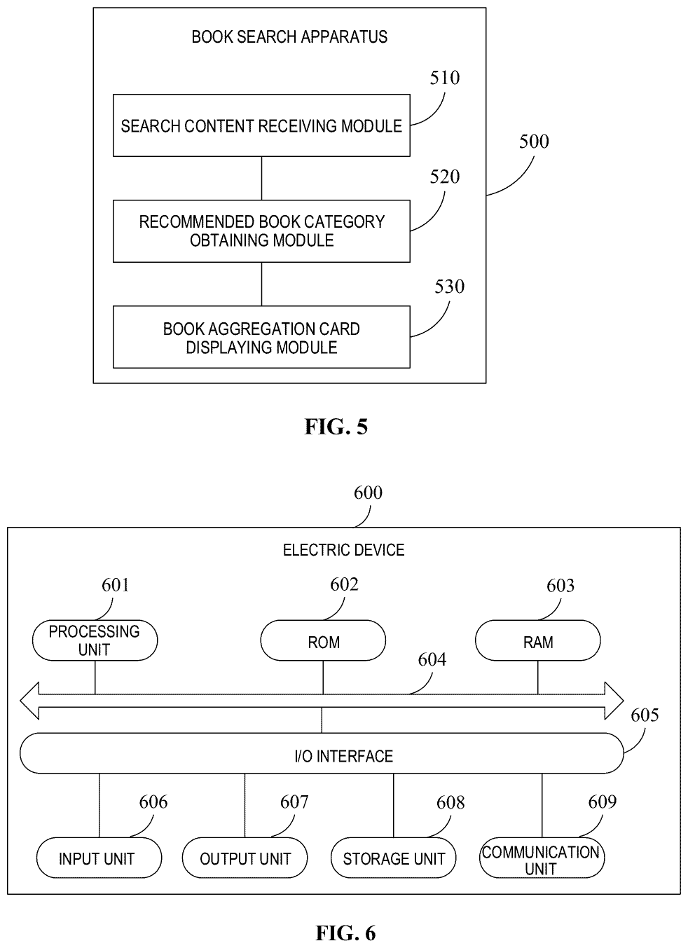

FIG. 5 is a structural schematic diagram of a book search apparatus provided by an embodiment of the present disclosure. As shown in FIG. 5, the book search apparatus 500 may comprise: a search content receiving module 510 configured for receiving target search content;
a recommended book category obtaining module 520 configured for obtaining a plurality of recommended book categories associated with the target search content, and book information corresponding to the respective recommended book categories; and
a book aggregation card displaying module 530 configured for generating a book aggregation card based on the respective recommended book categories and the book information, and displaying the book aggregation card on a search result page.

The book search apparatus provided in the embodiments of the present disclosure can acquire a plurality of recommended book categories related to target search content input by a user and book information corresponding to each recommended book category, and generate a book aggregation card based on each recommended book category and the book information, and display the book aggregation card on a search result page. Therefore, a user can directly view, on a search result page, a plurality of recommended book categories associated with target search content and book information subordinate to each recommended book category without repeating a book search operation and a search result screening operation, thereby reducing a user search cost, simplifying a book search flow, and improving book search efficiency.

In some embodiments, the book aggregate card display module 530 comprises:
a book aggregation card generating sub-module for generating a book aggregation card based on respective recommended book categories and book information;
a book aggregation card displaying sub-module for displaying a book aggregation card at a predetermined position of the search result page; in the book aggregation card, displaying the respective recommended book categories in a navigation style or a list style, displaying a target book category among the respective recommended book categories in a first predetermined style, displaying further book categories among the respective recommended book categories in a second predetermined style, and displaying the book information corresponding to the target book category.

In some embodiments, the book aggregation card displaying sub-module is specifically for:
in response to the target search content being category search content, displaying the book aggregation card in a first area of the search result page; wherein the first area is a display area adjacent to the top of the page; or
in response to the target search content being book search content, displaying the book aggregation card in a second area of the search result page; wherein the second area is an adjacent display area arranged after an area where a book search result is located.

In some embodiments, the book search apparatus 500 further comprises a book category switching module, which is configured for:
after generating the book aggregation card based on the respective recommended book categories and the book information and displaying the book aggregation card on the search result page, in response to a trigger operation on any of the further book categories among the respective recommended book categories, displaying the triggered further book category in the first predetermined style, displaying the untriggered further book categories and the target book category in the second predetermined style, and displaying the book information corresponding to the triggered further book category.

In some embodiments, the recommended book category is a primary book category or a secondary book category.

In some embodiments, the recommended book category is determined based on at least one of a first book category, a second book category and a third book category;
wherein the first book category comprises a book category to which a keyword corresponding to the target search content belongs, the second book category comprises a book category with an overlap degree of books corresponding to the first book category reaching a predetermined threshold, and the third book category comprises a book category extracted from book interaction behavior data corresponding to the target search content.

In some embodiments, in response to the target search content being category search content, the first book category comprises a book category matched with a keyword contained in the category search content; or
in response to the target search content being book search content, the first book category comprises a book category to which a category keyword corresponding to a target book hit by the book search content belongs, and/or a book category corresponding to a book attribute of the target book, wherein the book attribute includes at least one of author, chronological or event context corresponding to book content, book length and book status.

In some embodiments, the book interaction behavior data comprises at least one of a book category hit by continuously triggered category search content, a book hit by continuously triggered book search content and a book already read.

In some embodiments, the respective recommended book categories in the book aggregation card are ranked based on category relevance;
wherein the category relevance is determined based on at least one of search frequency of the respective recommended book categories, an overlap degree of books between a target book category and other respective book categories, and an associated search closeness between the respective recommended book categories, the target book category is one of the recommended book categories hit by the target search content, and the other book categories are the recommended book categories except the target book category.

In some embodiments, the book information comprises a book identifier; wherein the book identifier comprises a book picture and/or a book name; or
the book information comprises the book identifier and book interaction information.

The book search apparatus provided in the embodiment of the present disclosure can execute the book search method provided in any embodiment of the present disclosure, and has corresponding functional modules and beneficial effects for executing the method.

It should be noted that, in the foregoing embodiment of the book searching apparatus, the modules and submodules included therein are merely divided according to functional logic, but are not limited to the foregoing division, as long as corresponding functions can be implemented. In addition, specific names of the functional modules/submodules are only intended to distinguish them from each other, and are not intended to limit the scope of protection of the present disclosure.

Embodiments of the present disclosure further provide an electronic device. The electronic device may comprise a processor and a memory, and the memory may be used for storing executable instructions. The processor may be configured to read an executable instruction from the memory and execute the executable instruction to implement the book searching method in the above embodiment.

FIG. 6 shows a schematic diagram of a structure of an electronic device according to an embodiment of the present disclosure.

As shown in FIG. 6, the electronic device 600 may include processing units (e.g., a central processing unit, a graphic processor, etc.) 601 that may perform various suitable actions and processes in accordance with a program stored in a read only memory (ROM) 602 or a program loaded into a random access memory (RAM) 603 from a storage unit 608. In the RAM 603, various programs and data necessary for the operation of the information processing device 600 are also stored. The processing unit 601, the ROM 602, and the RAM 603 are connected to each other via a bus 604. An input/output interface (I/O interface) 605 is also connected to the bus 604.

In general, the following units may be connected to the I/O interface 605: input unit 606 including, for example, touch screens, touch pads, keyboards, mice, cameras, microphones, accelerometers, gyroscopes, etc.; an output unit 607 including, for example, a liquid crystal display (LCD), a speaker, a vibrator, and the like; a storage unit 608 including, for example, a magnetic tape, a hard disk, and the like; and a communication unit 609. The communication unit 609 can allow the electronic device 600 to wirelessly or wired communicate with other devices to exchange data.

It should be noted that, the electronic device 600 shown in FIG. 6 is only an example, and shall not impose any limitation on functions and application scope of the embodiments of the present disclosure. Although FIG. 6 shows the electronic device 600 with various means, it should be understood that not all of the means shown are required to be implemented or provided. More or fewer units may alternatively be implemented or provided.

In particular, the processes described above with reference to the flowcharts can be implemented as computer software programs in accordance with embodiments of the present disclosure. For example, embodiments of the disclosure include a computer program product comprising a computer program carried on a non-transitory computer-readable medium, the computer program comprising program code for performing the method as shown in the flowchart. In such an embodiment, the computer program may be downloaded from the network via the communication unit 609 and then installed, or installed from the storage 608, or installed from the ROM 602. The computer program, when executed by the processing unit 601, performs the above-described functions defined in the book searching method according to any embodiment of the present disclosure.

Embodiments of the present disclosure further provide a computer readable storage medium. The storage medium stores a computer program. When the computer program is executed by a processor, the processor is enabled to implement a book searching method in any embodiment of the present disclosure.

It should be noted that the computer readable medium in the present disclosure may be a computer readable signal medium or a computer readable storage medium, or any combination thereof. A computer-readable storage medium may be, for example, but not limited to, an electronic, magnetic, optical, electromagnetic, infrared, or semiconductor system, apparatus, or device, or any suitable combination of the foregoing. More specific examples of the computer readable storage medium may include, but are not limited to, an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the present disclosure, a computer readable storage medium may be any tangible medium that can contain or store a program for use by or in connection with an instruction execution system, apparatus, or device. While in the present disclosure, a computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may also be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including, but not limited to, wireline, optical fiber cable, RF (radio frequency), etc., or any suitable combination of the foregoing.

In some embodiments, clients, servers, may communicate using any currently known or future developed network protocol such as HTTP, and may be interconnected with any form or medium of digital data communication (e.g., a communication network). Examples of communication networks include a local area network (“LAN”), a wide area network (“WAN”), an internetwork (e.g., the Internet), and a peer-to-peer network (e.g., an ad hoc peer-to-peer network), as well as any currently known or future developed network.

The computer readable medium may be included in the electronic device, or may exist separately and not be installed in the electronic device.

The computer readable medium bears one or more programs. When the one or more programs are executed by the electronic device, the electronic device executes the steps of the book searching method described in any embodiment of the present disclosure.

In embodiments of the present disclosure, computer program code for carrying out operations of the present disclosure may be written in one or more programming languages, including but not limited to an object oriented programming language such as Java, Smalltalk, C++ or the like and conventional procedural programming languages, such as the “C” programming language or similar programming languages, or any combination thereof. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowchart and block diagrams in the drawings illustrate the architecture, functionality, and operation of possible implementations of devices, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The functions described herein above may be performed, at least in part, by one or more hardware logic components. For example, without limitation, exemplary types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

In the context of this disclosure, a machine-readable medium may be tangible media that may contain or store a program for use by or in connection with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of machine-readable storage media would include an electrical connection based on one or more wires, a portable computer diskette, a hard disk, a random access memory (RAM), a read-only memory (ROM), an erasable programmable read-only memory (EPROM or Flash memory), an optical fiber, a compact disc read-only memory (CD-ROM), an optical storage device, a magnetic storage device, or any suitable combination of the foregoing.

The foregoing description is merely illustrative of the preferred embodiments of the present disclosure and of the technical principles applied thereto, as will be appreciated by those skilled in the art, The disclosure of the present disclosure is not limited to the technical solution formed by the specific combination of the described technical features, At the same time, it should also cover other technical solutions formed by any combination of the described technical features or equivalent features thereof without departing from the described disclosed concept. For example, the above features and technical features having similar functions disclosed in the present disclosure (but not limited thereto) are replaced with each other to form a technical solution.

In addition, while operations are depicted in a particular order, this should not be understood as requiring that the operations be performed in the particular order shown or in sequential order. Multitasking and parallel processing may be advantageous in certain circumstances. Likewise, while several specific implementation details are included in the above discussion, these should not be construed as limiting the scope of the present disclosure. Certain features that are described in the context of separate embodiments can also be implemented in combination in a single embodiment. Conversely, various features that are described in the context of a single embodiment can also be implemented in multiple embodiments separately or in any suitable sub-combination.

Although the subject matter has been described in language specific to structural features and/or methodological acts, it is to be understood that the subject matter defined in the appended claims is not necessarily limited to the specific features or acts described above. Rather, the specific features and acts described above are merely exemplary forms of implementing the claims.

What is claimed is:

1. A book search method, comprising:
receiving target search content;
obtaining a plurality of recommended book categories associated with the target search content, and book information corresponding to respective recommended book categories; and
generating a book aggregation card based on the respective recommended book categories and the book information, and displaying the book aggregation card on a search result page.

2. The method of claim 1, wherein displaying the book aggregation card on the search result page comprises:
displaying the book aggregation card at a predetermined location of the search result page;
in the book aggregation card, displaying the respective recommended book categories in a navigation style or a list style, displaying a target book category among the respective recommended book categories in a first predetermined style, displaying further book categories among the respective recommended book categories in a second predetermined style, and displaying the book information corresponding to the target book category.

3. The method of claim 2, wherein in response to the target search content being category search content, displaying the book aggregation card at the predetermined location of the search result page comprises:
displaying the book aggregation card in a first area of the search result page, wherein the first area is a display area adjacent to the top of the page; or
in response to the target search content being book search content, displaying the book aggregation card at a predetermined location of the search result page comprises:
displaying the book aggregation card in a second area of the search result page, wherein the second area is an adjacent display area arranged after an area where a book search result is located.

4. The method of claim 2, wherein the method, after generating the book aggregation card based on the respective recommended book categories and the book information and displaying the book aggregation card on the search result page, further comprises:
in response to a trigger operation on any of the further book categories among the respective recommended book categories, displaying the triggered further book category in the first predetermined style, displaying the untriggered further book categories and the target book category in the second predetermined style, and displaying the book information corresponding to the triggered further book category.

5. The method of claim 1, wherein the recommended book category is a primary book category or a secondary book category.

6. The method of claim 1, wherein the recommended book category is determined based on at least one of a first book category, a second book category and a third book category;
wherein the first book category comprises a book category to which a keyword corresponding to the target search content belongs, the second book category comprises a book category with an overlap degree of books corresponding to the first book category reaching a predetermined threshold, and the third book category comprises a book category extracted from book interaction behavior data corresponding to the target search content.

7. The method of claim 6, wherein in response to the target search content being category search content, the first book category comprises a book category matched with a keyword contained in the category search content; or
in response to the target search content being book search content, the first book category comprises a book category to which a category keyword corresponding to a target book hit by the book search content belongs, and/or a book category corresponding to a book attribute of the target book, wherein the book attribute includes at least one of author, chronological or event context corresponding to book content, book length and book status.

8. The method of claim 6, wherein the book interaction behavior data comprises at least one of a book category hit by continuously triggered category search content, a book hit by continuously triggered book search content and a book already read.

9. The method of claim 1, wherein the respective recommended book categories in the book aggregation card are ranked based on category relevance;
wherein the category relevance is determined based on at least one of search frequency of the respective recommended book categories, an overlap degree of books between a target book category and other respective book categories, and an associated search closeness between the respective recommended book categories, the target book category is one of the recommended book categories hit by the target search content, and the other book categories are the recommended book categories except the target book category.

10. The method of claim 1, wherein the book information comprises a book identifier; wherein the book identifier comprises a book picture and/or a book name; or
the book information comprises the book identifier and book interaction information.

11-13. (canceled)

14. An electronic device, comprising:
a processor;
a memory for storing executable instructions;
wherein the processor is configured for reading the executable instructions from the memory and executing the executable instructions to implement a book search method, the method comprising:
receiving target search content;
obtaining a plurality of recommended book categories associated with the target search content, and book information corresponding to respective recommended book categories; and
generating a book aggregation card based on the respective recommended book categories and the book information, and displaying the book aggregation card on a search result page.

15. The device of claim 14, wherein displaying the book aggregation card on the search result page comprises:
displaying the book aggregation card at a predetermined location of the search result page;
in the book aggregation card, displaying the respective recommended book categories in a navigation style or a list style, displaying a target book category among the respective recommended book categories in a first predetermined style, displaying further book categories among the respective recommended book categories in a second predetermined style, and displaying the book information corresponding to the target book category.

16. The device of claim 15, wherein in response to the target search content being category search content, displaying the book aggregation card at the predetermined location of the search result page comprises:
displaying the book aggregation card in a first area of the search result page, wherein the first area is a display area adjacent to the top of the page; or
in response to the target search content being book search content, displaying the book aggregation card at a predetermined location of the search result page comprises:
displaying the book aggregation card in a second area of the search result page, wherein the second area is an adjacent display area arranged after an area where a book search result is located.

17. The device of claim 15, wherein the method, after generating the book aggregation card based on the respective recommended book categories and the book information and displaying the book aggregation card on the search result page, further comprises:
in response to a trigger operation on any of the further book categories among the respective recommended book categories, displaying the triggered further book category in the first predetermined style, displaying the untriggered further book categories and the target book category in the second predetermined style, and displaying the book information corresponding to the triggered further book category.

18. The device of claim 14, wherein the recommended book category is a primary book category or a secondary book category.

19. The device of claim 14, wherein the recommended book category is determined based on at least one of a first book category, a second book category and a third book category;
wherein the first book category comprises a book category to which a keyword corresponding to the target search content belongs, the second book category comprises a book category with an overlap degree of books corresponding to the first book category reaching a predetermined threshold, and the third book category comprises a book category extracted from book interaction behavior data corresponding to the target search content.

20. The device of claim 19, wherein in response to the target search content being category search content, the first book category comprises a book category matched with a keyword contained in the category search content; or
in response to the target search content being book search content, the first book category comprises a book category to which a category keyword corresponding to a target book hit by the book search content belongs, and/or a book category corresponding to a book attribute of the target book, wherein the book attribute includes at least one of author, chronological or event context corresponding to book content, book length and book status.

21. The device of claim 19, wherein the book interaction behavior data comprises at least one of a book category hit by continuously triggered category search content, a book hit by continuously triggered book search content and a book already read.

22. The device of claim 14, wherein the respective recommended book categories in the book aggregation card are ranked based on category relevance;
wherein the category relevance is determined based on at least one of search frequency of the respective recommended book categories, an overlap degree of books between a target book category and other respective book categories, and an associated search closeness between the respective recommended book categories, the target book category is one of the recommended book categories hit by the target search content, and the other book categories are the recommended book categories except the target book category.

23. A non-transitory computer readable storage medium, wherein the storage medium stores a computer program which, when is executed by a processor, causes the processor to implement a book search method, the method comprising:
receiving target search content;
obtaining a plurality of recommended book categories associated with the target search content, and book information corresponding to respective recommended book categories; and
generating a book aggregation card based on the respective recommended book categories and the book information, and displaying the book aggregation card on a search result page.
